(19) United States
(12) Patent Application Publication
(10) Pub. No.: US 2003/0018734 A1
(43) Pub. Date: Jan. 23, 2003

(54) Method and system for remotely programming and controlling a digital output device

(76) Inventors: Yingdong Luo, Betesda, MD (US); Tas Li, Shanghai (CN)

Correspondence Address: Lieberman & Brandsdorfer, LLC, 12221 McDonald Chapel Drive, Gaithersburg, MD, 20878-2252, US

(21) Appl. No.: 10/179,335

(22) Filed: Jun. 25, 2002

Related U.S. Application Data
(60) Provisional application No. 60/301,093, filed on Jun. 26, 2001.

(51) Int. Cl. G06F 15/16; G06F 15/173

(52) U.S. Cl. 709/208; 709/223

(57) ABSTRACT

The invention comprises a method and system for providing capabilities to program, control and display both messages and rich media contents on a network of information narrowcasting appliances from a remote location. The information narrowcasting appliance is a computer system that includes an embedded PC, a system-on-chip microprocessor, a wireless communications card, and a combination of digital LED displays and LCD displays. The displays are a self-contained structure, requiring no additional computer systems to control the displaying of contents or transferring of data. Additional output devices, including audio speakers, motion sensors, scent players, or RF ID sensors can be also added to enhance the level of information delivery and collection by the appliance.

### CROSS REFERENCE TO RELATED APPLICATION(S)

This is a non-provisional utility patent application claiming benefit of the filing date of U.S. provisional application serial No. 60/301,093 filed Jun. 26, 2001, and titled IE CONTROL RETAIL NETWORK.

### BACKGROUND OF THE INVENTION

1. Technical Field

This invention relates to a system and method for programming and controlling a network of electronic displays and/or digital audio players from a remote location.

2. Description of the Prior Art

Digital electronic displays and video monitors can be used as a means to communicate marketing and advertising information to consumers. For example, since their introduction in the marketplace, electronic displays have gained in popularity as an effective means of communicating audio and visual information. A substantial economic benefit could be provided to both retailers and advertisers if a large number of digital electronic displays, monitors, and/or audio players (collectively referred to herein as “digital output devices”) could be linked to create an on-site, point of purchase (“POP”) information and marketing network for the display of text, images and audio messages by retailers, merchandisers and external advertisers.

Conventional broadcasting (radio, TV, cable, satellite) can reach thousands of dispersed retail locations, but only with a standardized message that is not useful for influencing a disparate array of customers and related constituencies. As a result, a number of companies have attempted to establish digital advertising networks by connecting various electronic components based on computer system networking technology and installing programmable output devices at retail outlets. (Referred to herein as “Narrowcasting” solutions) All such prior systems require a much more complex infrastructure to support even the simplest message distribution.

In these prior systems, each output device requires a PC controller and an in-store or on-site server to control the on-site PCs. Available electronic systems for programmable electronic output devices therefore must rely on installing a PC (server) at each location and linking the devices by cables. Such systems are client-server systems by definition that are not scalable if the requirement is to network thousands of devices at multiple locations.

To date, there is no product available applying an information appliance approach that would allow retailers or advertisers to establish a large Narrowcasting network without the installation of a PC on-site and/or connecting cables and rewiring on-site at each location within the network. Accordingly, there is a need for an information appliance which can be used to fulfill the specified tasks that has limited hardware requirements.

### SUMMARY OF THE INVENTION

This invention comprises a method and system for providing capabilities to remotely program and control display of indicia and rich media content on a network of information narrowcasting appliances from a remote location.

A first aspect of the invention includes a method for remotely programming and controlling anetwork of digital output devices. The method includes entering instructions on a remote terminal and connecting the terminal to a control module at a remote location througha remote network. The instructions are transmitted from the terminal to the remote locaiton through the network. The instructions are translated into a data stream for delivery to a control module on a communication network. The instructions are then forwarded from the control module to a designated output device. The instructions are delivered from the control module to the designated output device under the control of an embedded processor.

A second aspect of the invention includes a system for remotely programming and controlling messages displayed on an output device. The system includes a computer terminal, a control modules in communication with the terminal and an output device, and a communication network adapted to communicate a data strweam from the terminal to the output device through the control module. The output device includes an embdeed processor and a wireless communication apparatus adapted to receive the data stream from the control module. The control module includes a wireless communicaiton apparatus adapted to receive and transmit data from the computer terminal.

A third aspect of the invention includes an article in the form of a computer-readable signal-bearing medium. The article includes means in the medium for communicating video data for display on a video receiving digital output device, means in the medium for communicating audio data for tranmission on an audio receiving digital output device, means in the medium for communicating text data for display on a text receiving digital output device, and means in the medium for processing and transmitting said data from a remote terminal to said output device. The processing and transmitting means may include a control unit having an embedded processor for processing said data and an embedded modem for receiving and transmitting said data.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of a control module

FIG. 2 is a block diagram illustrating the interconnection of several components of the system.

FIG. 3 is perspective view of the hardware components of the system according to the preferred embodiment of this invention, and is suggested for printing on the first page of the issued patent.

FIG. 4 is a flow chart illustrating processing of data.

### DESCRIPTION OF THE PREFERRED EMBODIMENT

### Overview

The invention encompasses a system and method for controlling operation of a network of digital output devices from a remote location. The apparatus is designed to control operation of a network of narrowcasting information appliances through a computer connected to a global computer network. Digital output devices may include digital LED displays, LCD monitors and/or audio players, and may also include future devices operating on a similar basis of digitally displaying information in the form of text, image and/or audio. The system and method disclosed herein operator under similar protocols for all digital output devices.

### Technical Background

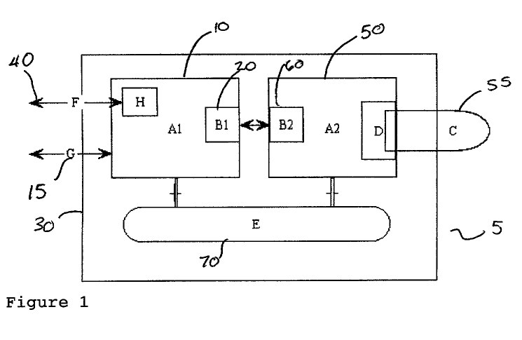

The system utilizes several interconnected apparatus to enable remote programming and control of a network of output devices. The primary embodiment of the system includes a control unit 5. The control unit is used to receive and transmit programming and control instructions to the output devices at any particular location. FIG. 1 is a schematic illustration of the control unit 5 with two controllers 10 and 50 enclosed within an enclosure 30 . In the current embodiment, the first controller 10 plugs into a telecommunication line at 15. This enables the controller 10 to receive data from a remote network, as well as to transmit data to a remote network. The second controller 50 unit includes a wireless communication apparatus 55 that enables the second controller 50 to communicate with an output device through a wireless area network. Each controller 10 and 50 includes an embedded microprocessor enabled with TCP/IP communication protocols. In addition, each controller includes a local area network interface 20 and 60, respectively. The second controller 50 has a wireless communication apparatus 55. In a preferred embodiment, the wireless communication apparatus is in the form of a network card programmed for wireless communication. However, in a preferred embodiment, the wireless communication apparatus may take on another form that enables the controller 50 to wireless communicate with an output device. In addition, each of the controllers 10 and 50 receive operating power from an embedded power supply 70. The first controller 10 includes a communication line interface 40 to enable a direct link from an embedded modem 35 to a telecommunication line, and a networking interface 15.

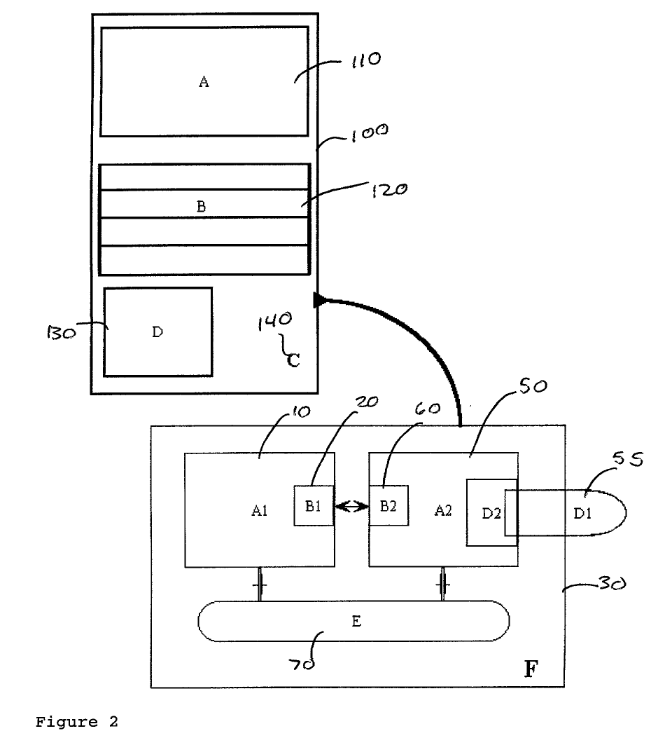

FIG. 2 is an illustration of the output device 100 which includes an RS232 standard interface compatibility. The output device 100 includes a set of information narrowcasting applications in the form of a video data display 110, a text data display 120, and an audio data display 130. The output device receives power for an external AC power supply 140 through a power supply cord. Once the output device 100 is plugged into the power supply 140, the video data display 110, the text data display 120 and the audio data display 130 are each on the local area network together with the controllers 10 and 50. In an alternative embodiment, the controllers 10 and 50 may be integrated with the output devices 110, 120 and 130. There are no external cables o wires connecting the controllers 10 and 50 with the output device 100. Upon receiving data through a telecommunication line 40, the controllers 10, 50 translate the instructions for communication to the specific information narrowcasting appliance through the wireless network. The embodiment shown in FIG. 2, is one controller 10, 50 in communication with an output device 100 having a video data output 110, a text data output 120 and an audio data output. However, the controller 10, 50 may also be in wireless communication with multiple output devices. Each output device may include a video data output, a text data output, and/or an audio data output. The control module 30 receives data through a remote network interface 15, processes the data, and forwards the data to an appropriate output device. Accordingly, the system enables multiple users to deliver data to multiple output devices in different locations.

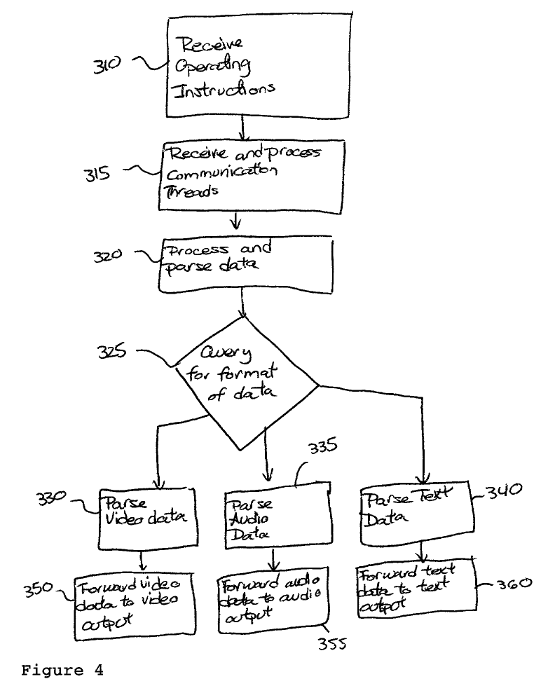

The control module 30 is adapted to communicate with both an external server and the output device. It essentially functions to receive and transmit programming and control instructions to the output device. FIG. 4 is a diagram of a layout of the system at a specific location. The control module 30 is located on within a communication range of the output device 100 and is in communication with the output device 100. This communication may be either through a cable, a communication line, or a wireless communication. Data parsed through the processor of the control module 30 is transmitted to the output device for display through a wireless communication network.

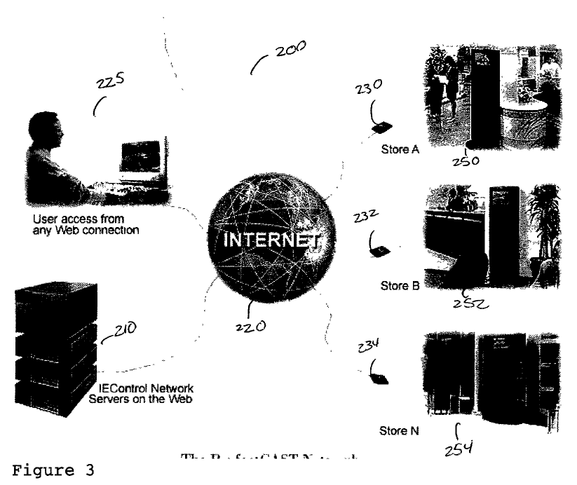

In a further embodiment of the invention, the control module may be in communication with a plurality of output devices. FIG. 3 is a block diagram 200 illustrating the communication link between the control modules 230, 232 and 234 and a plurality of output devices 250, 252 and 254, respectively Each output device 250, 252 and 254 has a unique address. This enables the control module 230, 232 and 234 to communicate with each output device on an individual basis or as a group. When the control module 230, 232 234 individually communicates with an output device 250, 252, 254 that is a part of a network of output devices, it must send the data to the address associated with the output device. Similarly, when the control module communicates with a series of output devices as a group, it must send the data to the grouping of addresses associated with each of the output devices. All of the commands can be controlled from the central processing unit, which initiates the commands and sends them to the output devices through the control module associated with the output device. The control module is adapted to receive the commands and to process them in a format that minimizes bandwidth.

The block diagram 200 of FIG. 3 shows the interconnection of the various hardware components of the system. The preferred embodiment of the remote control computer 210 comprised of two main components, a dialing processor and a server. The two components are interconnected to allow remote programming and control of the output devices in retail locations through either a voice interface or access to the global computer network. The remote computer functions as a server to house software designed to translate input programming and control codes to the control modules 230, 232, 234. The dialing processor receives programming and control codes from the server 210, and establishes a telecommunication link between the server 210 and the control modules 230, 232, 234. In addition, the server 210 includes a user interface for communicating instructions from the user to the control modules 230, 232, 234. Accordingly, the hardware stores and manages remote programming and control of all the output devices on the network.

The server 210 is physically connected to the global communication network 220. This connection allows a user to enter commands through a computer-input device 225. The server 210 is further connected to a dialing processor at a second end. At such time as the server 210 receives instructions for programming or control of a particular display, the server 210 operates the dialing processor to establish a communication link from the server 210 to the control module 230, 232, 234 for that particular display. The dialing processor receives dialing instructions from the server 210 to communicate with the control module 230, 232, 234. The dialing processor establishes a communication link between the server 210 and user directly to the control module 230, 232, 234 connected to the communication line at the designated telephone number. Once the dialing processor has established a communication link to the designated telephone number, the dialing processor produces a signal for communicating the control module 230, 232, 234. The signal is audible and operates at a level so as not to cause interference with other electronic products. Accordingly, the dialing processor acts as a communication interface between the server 210 and the output devices 250, 252 and 254.

FIG. 4 is a flow chart 300 illustrating the flow of data through the control module 30. Operating instructions are received by the control module through the wireless communication apparatus 310. The instruction are received in the form of communication threads and are processed through the embedded processor of the control module 315. The received data is processed and parsed 320. The system will query the data for the format of the data 325. Video data is parsed through a video data thread 330, audio data is parsed through an audio data stream 335, and text data is parsed through a text data stream 340. Thereafter, the data is forwarded to the appropriate output device 350, 355, and 360, respectively. If the parsed data is in video format, it is forwarded to the visual display apparatus of the control module 350. Similarly, if the parsed data is in audio format, the data is forwarded to the audio output device 355, and if the parsed data is text, the data is forwarded to the LED portion of the output device360. Accordingly, the output device is adapted to receive communication instructions and to process and parse the instructions for forwarding to the appropriate display component of the output device.

In addition to hardware components of the apparatus, the preferred embodiment further includes a software component for establishing communication among the different hardware components. The server receives communication instructions through connection to a global computer network. The software component is an interface between the user and the server. More specifically, the software component is accessible through a browser interface enabling adaptations to the particular access device being used, including hard-line phone, PC, mobile phone, PDA or any other Internet ready device. The associated database technology provides a uniform reference in relational database, XML storage, file system and memory. The database can cache frequently used objects or advertising script in its memory to provide high performance interaction and be easily extended with additional data types, languages, user roles, and industry-specific business rules. The related content data is stored as XML objects with layout methods to control its presentation, design improvement and code re-use. The design also provides a user-friendly page generator that dynamically generates web pages offering customers customized personalized interface access.

There are two user groups that may establish an account on the server through the software interface Merchandisers and Retailers. For purpose of determining the scope of the user groups, a network is defined as the group of connected output devices for one specific retailer. The system includes all networks that are established at various retail outlets. Merchandisers can access multiple networks established with multiple retailers after going through an authorization and purchase process for merchandising time slots; Retailers can only access their own individual network. Retailers are further divided into two sub-categories—Retail User Managers and Retail Location Users. User Managers have broader authorization and can access and modify messages on any specific output device in that retailer's network, while Location Users can only access and modify messages on the output devices in their specific store location.

For all users, the user account will store such information as the company name, user name, and password. For Retailer users, the user account will also store the number of stores for that retailer, the business category of stores, and a directory of output devices at the store locations, and will enable the user to deliver messages to any particular output device or groups of devices through a Promotions Manager, and obtain revenue information for any particular device or group of devices through a Statistics Manager. For Merchandiser users, the user account will also store such information as the business category of the merchandiser and the availability and cost of delivering messages to output devices at various retail locations, and will enable the user to deliver promotional messages to available output devices and obtain summaries of the location and cost of all output devices utilized by that merchandiser.

When either Retailer users or Merchandiser users select to deliver messages to output devices, the software activates the dialing processor which dials the telephone number(s) indicated for the control module for the selected output devices, and upon establishing a connection with the control module, transmits the message to the control module. The control module then transmits the message to the Information Narrowcasting Appliance through a wireless connection. Accordingly, the software is a communication interface for allowing the user to provide specific message instructions to any output device within the network.

### Advantages Over The Prior Art

The advantage of the system is that it provides a low-cost, scalable, and plug-andplay networking solution that can be rapidly deployed to an unlimited number of retail locations. To provide this result, the system pioneers the adaptation of Information appliances, embedded systems and wireless communications in the linking of a network of digital output devices.

In contrast to existing digital networks, the system establishes the priority of serving large retail chains internal need for delivering sales information on-site more efficiently and effectively. Traditionally, retailers have relied on a paper system to post sales information in stores. This becomes increasingly difficult and costly due to the expanding size of chain operations and rising labor costs.

By using the new system, the retailers can now deliver such information instantly to their chain of stores. This approach potentially can save millions of dollars in the reduction of labor costs for manually posting sales information on merchandise, and enhanced inventory management resulting from more effective communication with consumers. Moreover, the system can be linked with retailers inventory systems to create an integrated sales information delivery network on-site at various locations. In the long-term, the retailers can leverage such a system to test the effectiveness of various point-of-purchase promotional tactics and therefore be able to identify the most cost-effective consumer-triggering approach.

In sum, with no rewiring and no purchase or installation of PC's, retailers can create a network of individually addressable and programmable output devices, which can deliver customized text, audio or video messages to their customers at the point-of-purchase. Merchandise suppliers can also leverage the system to further maximize their return on investment in retail shelf space. Traditionally, these suppliers pay for in-store promotions such as preferential placement and distribution of coupon books on-site. The system enables a more prompt, eye-catching, and flexible channel to execute point of sale promotional messaging.

Finally, the system also has the potential to be leveraged as an out-of-home advertising channel by advertisers who need not be suppliers for the specific retailers. The system creates a new advertising channel that allows advertisers to more effectively target and reach their audience in an out-of-home environment at very attractive CPM rates. Whereas traditional outdoor advertising takes days or weeks to update, our technology reduces the lead-time for advertising and programming changes to hours or minutes. Advertisers are, therefore, able to modify their daily promotional messages to target specific parts of the day and feed in advertising updates at any time, which provides them with the ability to enhance the timeliness of their message, or react to changing marketing needs, with little incremental cost. In addition, since advertising on the system requires no physical production requirements, advertisers can put more of their advertising budget into acquiring additional advertising space rather than into the relatively high production charges associated with traditional outdoor and out-of-home advertisements. The speed and flexibility with which the system advertisers can adjust their advertising format and program, at little or no incremental cost, also provides extra advantages over traditional advertising media. More so than any other advertising medium, the system allows the purchase of advertising time in fractional units, and provides a means for advertisers to fine-tune their promotional messages delivery.

### Alternative Embodiments

It will be appreciated that, although specific embodiments of the invention have been described herein for purposes of illustration, various modifications may be made without departing from the spirit and scope of the invention. In particular, while the preferred embodiment described herein uses digital LED displays, LCD monitors and audio players as the output device technology, there is flexibility to use other forms of digital displaying technology which display text, images or audio messages. These embodiments will function similarly to the system described herein with a control module and a telecommunications link for receiving programming and controlling instructions for the output devices. Accordingly, the scope of protection of this invention is limited only by the following claims and their equivalents.

We claim:

1. A method for remotely programming and controlling a network of digital output devices, comprising:
(a) entering instructions on a remote terminal;
(b) connecting the terminal to a control module at a remote location through a remote network;
(c) transmitting said instructions from said terminal to said remote location through said remote network;
(d) translating instructions into a data stream for delivery to a control module on a communication network;
(e) forwarding instructions from the control module to a designated output device; and
(f) delivering said instructions from the control module to the output device under the control of an embedded controller.

2. The method of claim 1, further comprising said remote terminal dialing a telephone number assigned to said control module.

3. The method of claim 1, further comprising translating user interface instructions into a programming language selected from the group consisting of: XML, HTML, and combinations thereof.

4. The method of claim 3, further comprising transporting said translated interface instructions through TCP/IP communication protocols.

5. The method of claim 1, wherein the step of transmitting said instructions includes a medium selected from the group consisting of: a telecommunication cable, a wireless communication apparatus, and combinations thereof.

6. The method of claim 1, wherein said output device is selected from the group consisting of: a digital LED display, a digital LCD monitor, a digital audio player, an integrated combination of a digital LED display, a digital LCD monitor and/or a digital audio player, and combinations thereof.

7. A system for remotely programming and controlling messages displayed on an output device, comprising:
(a) a computer terminal;
(b) a control module in communication with said terminal and an output device;
(c) a communication network adapted to communicate a data stream from said terminal to said output device through said control module;

8. The system of claim 7, wherein said output device includes an embedded processor.

9. The system of claim 7, wherein said output device includes a wireless communication apparatus adapted to receive said data stream from said control module.

10. The system of claim 7, wherein said control module includes a wireless communication apparatus adapted to receive and transmit data from the terminal.

11. The system of claim 7, wherein said control module includes a modem to connect to a remote network.

12. The system of claim 11, wherein said modem is selected from the group consisting of: a telephone modem, a DSL modem, and combinations thereof.

13. The system of claim 7, wherein said output device is selected from the group consisting of: a digital LED, a digital LCD, a digital audio player, and an integrated combination of a digital LED, a digital LCD and/or a digital audio player, and combinations thereof.

14. The system of claim 7, wherein said control module is adapted to receive and transmit communication data from said remote terminal to said output device.

15. The system of claim 7, wherein said remote terminal comprises an oral interface adapted to receive instructions for forwarding to said control module.

16. The system of claim 7, wherein said remote terminal comprises a web-based interface adapted to receive instructions for forwarding to said control module.

17. An article comprising:
a computer-readable signal-bearing medium;
means in the medium for communicating video data for display on a video receiving digital output device;
means in the medium for communicating audio data for transmission on an audio receiving digital output device;
means in the medium for communicating text data for display on a text receiving digital output device;
means in the medium for processing and transmitting said data from a remote terminal to said output device.

18. The article of claim 17, wherein the medium is selected from the group of: a recordable data storage medium and a modulated carrier signal.

19. The article of claim 17, wherein said processing and transmitting means includes a control unit having an embedded processor for processing said data and an embedded modem. for receiving and transmitting said data
